(19) United States
(12) Patent Application Publication
(10) Pub. No.: US 2016/0307563 A1
(43) Pub. Date: Oct. 20, 2016

(54) METHODS AND SYSTEMS FOR DETECTING PLAGIARISM IN A CONVERSATION

(71) Applicant: XEROX CORPORATION, Norwalk, CT (US)

(72) Inventors: Kundan Shrivastava, Bangalore (IN); Om D. Deshmukh, Bangalore (IN); Geetha Manjunath, Bangalore (IN)

(21) Appl. No.: 14/687,042

(22) Filed: Apr. 15, 2015

(51) Int. Cl. G10L 15/08; G06F 17/27; G06F 17/30

(52) U.S. Cl. CPC G10L 15/08; G06F 17/30864; G06F 17/2775

(57) ABSTRACT

The disclosed embodiments illustrate methods and systems for detecting plagiarism in a conversation. The method includes receiving first input corresponding to a query from a first user in said conversation. The first input corresponds to at least a first audio signal received from said first user. The method includes receiving second input corresponding to one or more responses received from a second user in response to said query. The second input corresponds to at least a second audio signal received from said second user. Thereafter, the method includes determining a first score for one or more websites, based on a comparison between said one or more responses and content obtained from said one or more websites in response to said query. The first score is a measure of a similarity between said one or more responses and said content. The method is performed by one or more microprocessors.

### TECHNICAL FIELD

The presently disclosed embodiments are related, in general, to detecting plagiarism. More particularly, the presently disclosed embodiments are related to methods and systems for detecting plagiarism in an online/telephonic conversation.

### BACKGROUND

Companies may usually have human resources (HR) departments that are responsible for managing staff as well as other employee related issues. Further, the HR department may be responsible for hiring one or more potential candidates. Hiring the one or more potential candidates may involve conducting various rounds of interviews. As per availability of an interviewer and an interviewee, the various rounds of interviews may include one or more interviews that may not require physical presence of the interviewee. Such interviews may correspond to a telephonic interviews or a video conferencing interviews.

Usually, such interviews (in which the physical presence of the interviewee is not required) may provide leeway to the interviewee to cheat during the interview, for example, the interviewee may obtain answers to the questions (asked by the interviewer) from popular question answering or discussion forum from internet.

### SUMMARY

According to embodiments illustrated herein, there is provided a method for detecting plagiarism in a conversation. The method includes receiving a first input corresponding to a query from a first user in said conversation. The first input corresponds to at least a first audio signal received from said first user. The method further includes receiving a second input corresponding to one or more responses received from a second user in response to said query. The second input corresponds to at least a second audio signal received from said second user. Thereafter, the method includes determining a first score for one or more websites, based on a comparison between said one or more responses and content obtained from said one or more websites in response to said query. The first score is a measure of a similarity between said one or more responses and said content. The method is performed by one or more microprocessors.

According to embodiments illustrated herein, there is provided a method for detecting plagiarism in an interview. The method includes extracting one or more first words from a first audio signal received from an interviewer, and one or more second words from a second audio signal received from an interviewee in said interview. The first audio signal corresponds to a query asked by said interviewer to said interviewee. Further, the second audio signal corresponds to at least a response of said interviewee. The method further includes processing said one or more first words, and said one or more second words to remove one or more stop words, convert digits to textual forms, identify part of speech, or stem said one or more first words, said one or more second words. The method further includes creating said query from said one or more first words. The method further includes said query to one or more websites to obtain content. Each of said content includes one or more phrases or one or more third words. The method further includes determining a first score based on a comparison between said one or more second words and said content obtained from said one or more websites in response to said query. The first score is a measure of a similarity between said one or more second words and said content. The method is performed by one or more microprocessors.

According to embodiments illustrated herein, there is provided a system for detecting plagiarism in a conversation. The system includes one or more microprocessors configured to receive a first input corresponding to a query from a first user in said conversation. The first input corresponds to at least a first audio signal received from said first user. The system further includes one or more microprocessors configured to receive a second input corresponding to one or more responses received from a second user in response to said query. The second input corresponds to at least a second audio signal received from said second user. The system includes one or more microprocessors configured to determine a first score for one or more websites, based on a comparison between said one or more responses and content obtained from said one or more websites in response to said query. The first score is a measure of a similarity between said one or more responses and said content.

According to embodiments illustrated herein, there is provided a computer program product for use with a computing device. The computer program product comprises a non-transitory computer readable medium, the non-transitory computer readable medium stores a computer program code for detecting plagiarism in a conversation. The computer program code is executable by one or more microprocessors to receive a first input corresponding to a query from a first user in said conversation. The first input corresponds to at least a first audio signal received from said first user. The computer program code is further executable by said one or more microprocessors to receive a second input corresponding to one or more responses received from a second user in response to said query. The second input corresponds to at least a second audio signal received from said second user. Thereafter, the computer program code is further executable by said one or more microprocessors to determine a first score for one or more websites, based on a comparison between said one or more responses and content obtained from said one or more websites in response to said query. The first score is a measure of a similarity between said one or more responses and said content.

### BRIEF DESCRIPTION OF DRAWINGS

The accompanying drawings illustrate the various embodiments of systems, methods, and other aspects of the disclosure. Any person with ordinary skills in the art will appreciate that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another, and vice versa. Further, the elements may not be drawn to scale.

Various embodiments will hereinafter be described in accordance with the appended drawings, which are provided to illustrate and not to limit the scope in any manner, wherein similar designations denote similar elements, and in which:

FIG. 1 is a block diagram illustrating a system environment in which various embodiments may be implemented;

FIG. 2 is a block diagram illustrating a system, in accordance with at least one embodiment;

FIG. 3 is a flowchart illustrating a method for detecting plagiarism in a conversation, in accordance with at least one embodiment;

FIG. 4 is a block diagram illustrating a graphical user interface presented to a first user, in accordance with at least one embodiment; and

FIG. 5 is another block diagram illustrating a system environment in which various embodiments may be implemented.

### DETAILED DESCRIPTION

The present disclosure is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. For example, the teachings presented and the needs of a particular application may yield multiple alternative and suitable approaches to implement the functionality of any detail described herein. Therefore, any approach may extend beyond the particular implementation choices in the following embodiments described and shown.

References to “one embodiment,” “at least one embodiment,” “an embodiment,” “one example,” “an example,” “for example,” and so on indicate that the embodiment(s) or example(s) may include a particular feature, structure, characteristic, property, element, or limitation but that not every embodiment or example necessarily includes that particular feature, structure, characteristic, property, element, or limitation. Further, repeated use of the phrase “in an embodiment” does not necessarily refer to the same embodiment.

Definitions: The following terms shall have, for the purposes of this application, the meanings set forth below.

“Plagiarism” refers to a wrongful appropriation of someone ideas, thoughts, expressions, or content. In an embodiment, the plagiarism may correspond to copying content from sources such as websites. For example, a person is giving an answer to a question in an interview, and he is referring to the content on a website for the answer, then such an act is referred to as the plagiarism.

“An interviewer” refers to an employee of an organization, or an outsourced employee, who may be responsible to recruit a candidate for a job opening in an organization. In order to recruit the candidate, the interviewer may ask questions or queries to the candidate to test the candidate on one or more skills required for the job opening. The questions may be conveyed to the candidate using any known communication medium. Hereinafter, the interviewer may be referred as a first user.

“An interviewee” refers to a candidate, or an applicant, who may apply for a job in the organization. In an embodiment, the interviewee may respond to one or more questions or queries asked by the first user in the conversation. Hereinafter, the interviewee may be referred as a second user.

“Conversation” refers to a form of an interactive communication that may lead to an interchange of thoughts, ideas, etc., by spoken words. In an embodiment, the conversation may takes place between the first user and the second user over any known communication medium for example, face to face, telephonic, video conference, virtual communication mediums such as text communication, or a chat window.

A “query” refers to a search query provided by the first user as a speech input or a text input. The speech input may include one or more search terms associated with the search query. For example, “Where is Alabama?” is a search query that is spoken into the system for searching purposes. In an embodiment, the query may be asked by the first user to the second user in the conversation. For example, what is data encapsulation?

An “input” refers to an audio input received from a user. In an embodiment, the audio input may be a response for the query, or a voice-based query. In an embodiment, the input may correspond to a first input and a second input. In an embodiment, the first input may correspond to the query asked by the first user in the conversation. On the other hand, the second input may correspond to one or more responses from the second user in response to the query.

A “measure of similarity” refers to a degree of similarity between a first text string and a second text string. In an embodiment, the measure of similarity may be determined by comparing the content obtained from one or more websites with the one or more responses of the second user in response to the query asked by the first user. Hereinafter, the measure of similarity may be referred as a first score.

A “measure of dissimilarity” refers to a degree of dissimilarity between a first text string and a second text string. In an embodiment, the measure of dissimilarity may be determined by comparing the content obtained from one or more websites with the one or more responses of the second user in response to the query asked by the first user. Hereinafter, the measure of dissimilarity may be referred as a second score.

“An audio signal” refers to a signal that is perceivable by a human ear. In an embodiment, the audio input may correspond to a first audio signal, or a second audio signal. In an embodiment, the first audio signal may correspond to the audio signal received from the first user in the conversation. In an embodiment, the first audio signal may correspond to a query asked by the first user. Similarly, the second audio signal may correspond to the audio signal received from the second user in the conversation. In an embodiment, the second audio signal may correspond to a response for the query asked by the first user in the conversation.

“Websites” refer to a set of web pages hosted online on the World Wide Web. In an embodiment, the content of the websites may be discovered using a web crawler/search engine. In an embodiment, the websites may be utilized to obtain one or more outputs for the one or more questions or queries.

“Content” refers to substantive information that is to be expressed through some medium such as speech, writing, etc. In an embodiment, the content may be obtained from the one or more websites in response to the query entered by the first user.

“Stemming” may refer to a process of transforming a word to its original form. The stemming may transform each of the one or more words associated with a multimedia content to a stem form. For example, if the one or more words include words such as “finding”, “find”, “finds”, each of the one or more words are transformed to respective root form “find”.

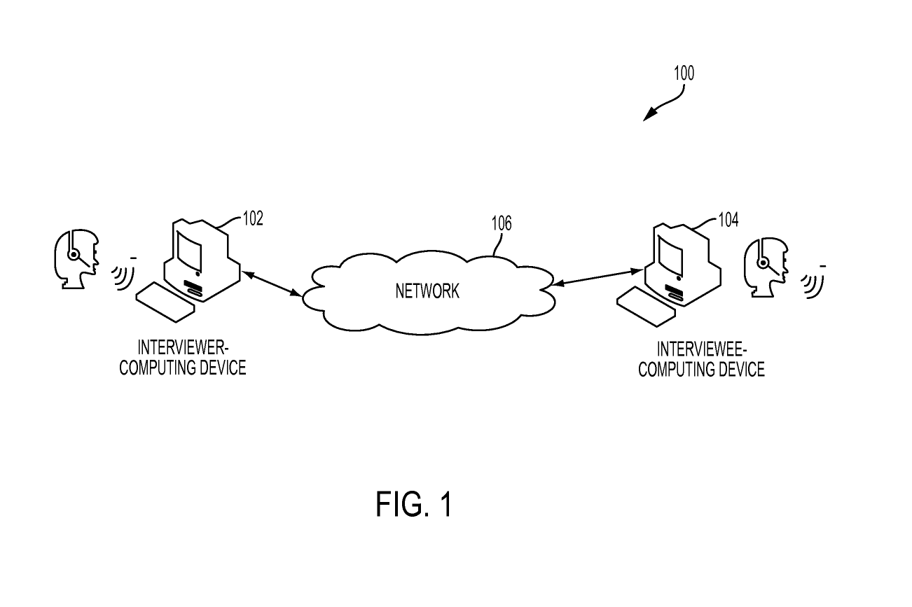

FIG. 1 is a block diagram illustrating a system environment 100 in which various embodiments may be implemented. The system environment 100 includes an interviewer-computing device 102, an interviewee-computing device 104, and a network 106. Various devices in the system environment 100 (e.g., the interviewer-computing device 102, and the interviewee-computing device 104) may be interconnected over the network 106.

The interviewer-computing device 102 includes one or more processors coupled to one or more memories. The one or more memories may include computer readable instructions that are executable by the one or more processors to perform predetermined operations. In an embodiment, the predetermined operation may correspond to detecting plagiarism in a conversation. In an embodiment, the interviewer-computing device 102 may be used by an interviewer. In an embodiment, the interviewer-computing device 102 may receive an input from the interviewer to initiate a call with the interviewee in an interview. On receiving the input, the interviewer-computing device 102 may initiate a VoIP session with the interviewee-computing device 104. In an embodiment, the scope of the disclosure is not limited to setting the VoIP session with the interviewee-computing device 104. In an embodiment, the interviewer-computing device 102 may utilize any known protocol to initiate the call with the interviewee-computing device 104. In an embodiment, the interviewer may utilize an audio capturing device attached or coupled to the interviewer-computing device 102 to communicate with the interviewee. In an embodiment, the interviewer-computing device 102 may process the audio signal captured by the audio capturing device (i.e., the audio signal corresponding to the interviewer) and the audio signal received from the interviewee-computing device 104 over the network 106. Hereinafter, the interviewer has been referred to as a first user.

In an embodiment, the interviewer-computing device 102 may receive a first audio signal through the audio capturing device attached or coupled to the interviewer-computing device 102. In an embodiment, the first audio signal may correspond to the first user asking a query to the interviewee. The interviewer-computing device 102 may extract one or more first words from the first audio signal. Based on the extracted one or more first words, the interviewer-computing device 102 may process the one or more first words to remove one or more stop words, convert digits to textual forms, identify part of speech for each of the one or more first words, or stem the one or more first words. In an embodiment, the interviewer-computing device 102 may further create a textual query from the processed one or more first words. Thereafter, the interviewer-computing device 102 queries one or more websites using the textual query to obtain content.

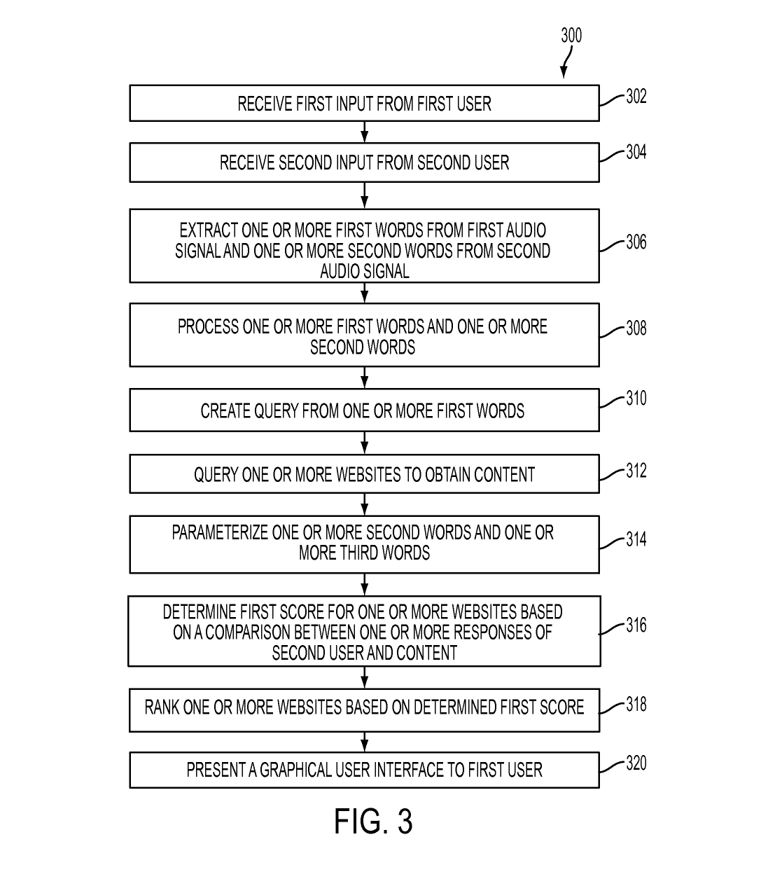

Further, the interviewer-computing device 102 may receive a second audio signal from the interviewee-computing device 104 over the network 106. In an embodiment, the second audio signal may correspond to one or more responses of the second user to the query asked by the first user (i.e., the interviewer). In an embodiment, the interviewer-computing device 102 may analyze the second audio signal to determine a delay between a time instance, when the first audio signal was transmitted to the interviewee-computing device 104, and a time instance, when the second audio signal is received from the interviewee-computing device 104. Similarly, the interviewer-computing device 102 may extract one or more second words from the second audio signal. Thereafter, the interviewer-computing device 102 may process the one or more second words in a manner similar to the processing of the one or more first words, as discussed above. In an embodiment, the interviewer-computing device 102 may determine a first score for each of the one or more websites based on a comparison between the one or more responses and the content obtained from the one or more websites, in response to the query. Based on the determined first score, the interviewer-computing device 102 may rank the one or more websites. Further, the interviewer-computing device 102 may present a graphical user interface (GUI) to the first user to present a list of ranked websites. Further, the GUI may include a transcription of the one or more responses received from the second user. The determination of the first score has been described later in conjunction with FIG. 3.

In an alternate embodiment, the call with the interviewee-computing device 104 may not be initiated by the interviewer-computing device 102. The call may be initiated by a separate computing device such as a mobile device of the first user. In such a scenario, the first user may switch the mobile device in a speaker mode for the audio signal to be captured by the audio capturing device attached or coupled to the interviewer-computing device 102.

In an alternate embodiment, the interviewer-computing device 102 may determine a second score based on the comparison between the one or more responses of the second user for the query, and the content obtained from the one or more websites in response to the query. The second score may correspond to a measure of dissimilarity between the one or more responses and the content. Based on the determined second score, the interviewer-computing device 102 may rank the one or more websites.

The interviewer-computing device 102 may be realized through a variety of computing devices, such as a desktop, a computer server, a laptop, a personal digital assistant (PDA), a tablet computer, and the like.

A person having ordinary skill in the art would understand that the scope of the disclosure is not limited to the interviewer-computing device 102 determining the plagiarism. In such a scenario, the interviewer-computing device 102 may send the first audio signal (corresponding to the query) and the second audio signal (corresponding to the one or more responses) to an application server for analysis. The application server (not shown in FIG. 1) may determine the first score and the second score. Further, the application server may facilitate a display of the first score and the second score on a user interface on the interviewer-computing device 102.

In an embodiment, the application server may include one or more processors and one or more memories. The one or more memories may include one or more computer readable code that may be executable by the one or more processors in the application server to analyze the first audio signal and the second audio signal. In an embodiment, the application server may determine the plagiarism based on the analysis.

The interviewee-computing device 104 may refer to a computing device that includes one or more processors coupled to one or more memories. The one or more memories may include computer readable instructions that are executable by the one or more processors to perform predetermined operations. In an embodiment, one of the predetermined operations may correspond to responding to the query asked by the interviewer. In an embodiment, the interviewee-computing device 104 may be used by an interviewee. Hereinafter, the interviewee has been referred to as a second user. In an embodiment, the interviewee-computing device 104 may receive a call from the interviewer-computing device 102 for an interview. In an embodiment, the second user may utilize an audio capturing device attached or coupled to the interviewee-computing device 104 to communicate with the first user. In an embodiment, the interviewee-computing device 104 may record the audio signal captured by the audio capturing device (i.e., audio signal received from the second user). In an embodiment, the second user associated with the interviewee-computing device 104 may receive the query from the first user. Based on the received query, the second user associated with the interviewee-computing device 104 may provide a second input. The second input may correspond to a second audio signal received from the second user through the audio capturing device. In an embodiment, the second audio signal may correspond to the one or more responses to the query asked by the first user.

In an embodiment, the second user may utilize the interviewee-computing device 104 to query one or more websites to obtain content related to the query asked by the first user. Examples of the one or more websites may include, but are not limited to, Yahoo, Google, or Wikipedia. In such a scenario, the second user may utilize the content obtained from the one or more websites to respond to the query. In an alternate embodiment, the interviewee-computing device 104 may include suitable hardware that may be capable of reading the one or more storage mediums (e.g., CD, DVD, or Hard Disk). Such storage mediums may include content that may correspond to responses for the query. The interviewee-computing device 104 may be realized through a variety of computing devices, such as a desktop, a computer server, a laptop, a personal digital assistant (PDA), a tablet computer, and the like.

The network 106 corresponds to a medium through which content and messages flow between various devices of the system environment 100 (e.g., the interviewer-computing device 102, and the interviewee-computing device 104). Examples of the network 106 may include, but are not limited to, a Wireless Fidelity (Wi-Fi) network, a Wide Area Network (WAN), a Local Area Network (LAN), or a Metropolitan Area Network (MAN). Various devices in the system environment 100 can connect to the network 106 in accordance with various wired and wireless communication protocols such as Transmission Control Protocol and Internet Protocol (TCP/IP), User Datagram Protocol (UDP), and 2G, 3G, or 4G communication protocols.

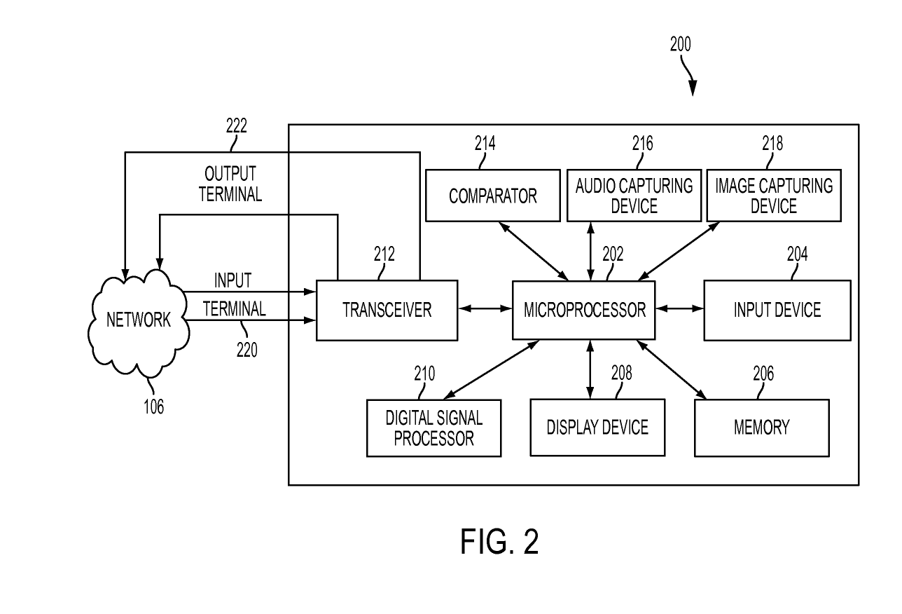

FIG. 2 is a block diagram illustrating a system 200, in accordance with at least one embodiment. In an embodiment, the system 200 has been considered to be an interviewer-computing device 102 for the purpose of ongoing description.

The interviewer-computing device 102 includes a microprocessor 202, an input device 204, a memory 206, a display device 208, a digital signal processor 210, a transceiver 212, a comparator 214, an audio capturing device 216, and an image capturing device 218. The microprocessor 202 is coupled to the input device 204, the memory 206, the display device 208, the digital signal processor 210, the transceiver 212, the comparator 214, the audio capturing device 216, and the image capturing device 218. The transceiver 212 may connect to the network 106 through the input terminal 220 and the output terminal 222.

The microprocessor 202 includes suitable logic, circuitry, and/or interfaces that are operable to execute one or more instructions stored in the memory 206 to perform predetermined operations. The microprocessor 202 may be implemented using one or more microprocessor technologies known in the art. Examples of the microprocessor 202 include, but are not limited to, an x86 microprocessor, an ARM microprocessor, a Reduced Instruction Set Computing (RISC) microprocessor, an Application Specific Integrated Circuit (ASIC) microprocessor, a Complex Instruction Set Computing (CISC) microprocessor, or any other microprocessor.

The input device 204 may comprise suitable logic, circuitry, interfaces, and/or code that may be operable to receive a first input from the first user. The first input may correspond to a query asked by the first user to the second user in the interview. The input device 204 may be operable to communicate with the microprocessor 202. It may be apparent to a person skilled in the art that the input device 204 may be a part of the interviewee-computing device 104. In such type of scenario, the input device 204 may receive a second input from the second user associated with the interviewee-computing device 104. Examples of the input device 204 may include, but are not limited to, a touch screen, a keyboard, a mouse, a joystick, a microphone, a camera, a motion sensor, a light sensor, and/or a docking station.

The memory 206 stores a set of instructions and data. Some of the commonly known memory implementations include, but are not limited to, a random access memory (RAM), a read only memory (ROM), a hard disk drive (HDD), and a secure digital (SD) card. Further, the memory 206 includes the one or more instructions that are executable by the microprocessor 202 to perform specific operations. It is apparent to a person with ordinary skills in the art that the one or more instructions stored in the memory 206 enable the hardware of the system 200 to perform the predetermined operations.

The display device 208 may comprise suitable logic, circuitry, interfaces, and/or code that may be operable to render a graphical user interface. In an embodiment, the display device 208 may enable the first user to enter the query. Further, the display device 208 may display content of the one or more websites in response to the query. In an embodiment, the display device 208 may display the first score associated with each of the one or more websites. In an embodiment, the display device 208 may be realized through several known technologies such as, but not limited to, Cathode Ray Tube (CRT) based display, Liquid Crystal Display (LCD), Light Emitting Diode (LED) based display, Organic LED display technology, and Retina display technology. It may be apparent to a person skilled in the art that the display device 208 may be a part of the interviewee-computing device 104. In such type of scenario, the display device 208 may display one or more responses from the second user in response to the query. In such a scenario, the display device 208 may be a touch screen that enables the user to provide the one or more responses. In an embodiment, the touch screen may correspond to at least one of a resistive touch screen, capacitive touch screen, or a thermal touch screen. In an embodiment, the display device 208 may receive feedback through a virtual keypad, a stylus, a gesture, and/or touch based input.

The digital signal processor 210 is a processor configured to perform one or more digital processing/analysis operations on an audio signal of the interview. In an embodiment, the digital signal processor 210 may analyze the first audio signal corresponding to the first user and the second audio signal (received from the second user). Further, the digital signal processor 210 may extract the one or more first words from the first audio signal and the one or more second words from the second audio signal, by utilizing one or more speech recognition techniques. Thereafter, the digital signal processor 210 may process the one or more first words and the one or more second words to remove one or more stop words, convert digits to textual forms, identify part of speech for each first word, or stem the one or more first words and the one or more second words. In an embodiment, the digital signal processor 210 may include one or more electronic circuits and/or gates configured to perform one or more predefined digital signal processing operations. Examples of the one or more predefined digital signal processing operations include, but are not limited to, a signal transformation (e.g., conversion of a signal from time to frequency domain and vice versa), a noise reduction, a signal filtration, a signal thresholding, a signal attenuation, and so on. Though the digital signal processor 210 is depicted as separate from the microprocessor 202, a person skilled in the art would appreciate that the scope of the disclosure is not limited to realizing the digital signal processor 210 as a separate entity. In an embodiment, the digital signal processor 210 may be implemented within the microprocessor 202 without departing from the spirit of the disclosure.

The transceiver 212 transmits and receives messages and data to/from various components of the system environment 100 (e.g., the interviewee-computing device 104) over the network 106. In an embodiment, the transceiver 212 may initiate a call with the second user in an interview. Further, the transceiver 212 may receive a second input corresponding to one or more responses from the second user in response to the query from the interviewee-computing device 104. In an embodiment, the transceiver 212 may query one or more websites to obtain the content related to the query. In an embodiment, the transceiver 212 is coupled to the input terminal 220 and the output terminal 222 through which the transceiver 212 may receive and transmit data/messages, respectively. Examples of the input terminal 220 and the output terminal 222 include, but are not limited to, an antenna, an Ethernet port, a USB port, or any other port that can be configured to receive and transmit data. The transceiver 212 transmits and receives data/messages in accordance with the various communication protocols such as, TCP/IP, UDP, and 2G, 3G, or 4G communication protocols through the input terminal 220 and the output terminal 222.

The comparator 214 is configured to compare at least two input signals to generate an output signal. In an embodiment, the output signal may correspond to either ‘1’ or ‘0’. In an embodiment, the comparator 214 may generate output ‘1’ if the value of a first signal (from the at least two signals) is greater than a value of the second signal (from the at least two signals). Similarly, the comparator 214 may generate an output ‘0’ if the value of the first signal is less than the value of the second signal. In an embodiment, the comparator 214 may compare the one or more responses received from the second user in response to the query and the content obtained from the one or more websites in response to the query. In an embodiment, the comparator 214 may be realized through either software technologies or hardware technologies known in the art. Though, the comparator 214 is shown outside the microprocessor 202 in FIG. 2, a person skilled in the art would appreciate that the comparator 214 may be implemented inside the microprocessor 202 without departing from the scope of the disclosure.

The audio capturing device 216 receives the first audio signal from the first user. The audio capturing device 216 may include a microphone (not shown) that may be coupled to an ND converter (not shown) that converts the analog audio signal to a digital signal for further processing. It may be apparent to a person skilled in the art that the audio capturing device 216 may be a part of the interviewee-computing device 104. In such type of scenario, the audio capturing device 216 may receive the second audio signal from the second user. Examples of the microphone may include any acoustic-to-electric transducer. In an embodiment, the audio capturing device 216 may be in-built into the system 200. In an alternate embodiment, the audio capturing device 216 may be external to the system 200 and communicatively coupled to the system 200 through any wired or wireless connection. Examples of the wired connection may include, but are not limited to, a microphone jack cable, a USB cable, or any other wired connection. Wireless connection may include, but is not limited to, Bluetooth, Wireless LAN (WLAN), Wireless Personal Area Network (PAN), or any other wireless connection.

The image capturing device 218 captures the video stream of the first user while the first user asking a query to the second user on the interviewer-computing device 102. In an embodiment, the image capturing device may include a camera (not shown) that may be in-built in the interviewer-computing device 102. In an alternate embodiment, the image capturing device 218 may be external to the interviewer-computing device 102 and communicatively coupled to the interviewer-computing device 102 through any wired or wireless connection. A wired connection may include, but is not limited to, a Universal Serial Bus (USB) cable, a High-Definition Multimedia Interface (HDMI) cable or any other wired connection. A wireless connection may include, but is not limited to, Bluetooth, Wireless LAN (WLAN), Wireless Personal Area Network (WPAN), or any other wireless connection. It may be apparent to a person skilled in the art that the image capturing device 218 may be a part of the interviewee-computing device 104. In such type of scenario, the image capturing device 218 may capture the video stream of the second user while the second user responding to a query asked by the first user. The image capturing device 218 may be implemented using one or more image sensing technologies known in the art such as, but not limited to, a Charge-Coupled Device (CCD) based image sensor and a Complementary Metal Oxide Semi-conductor (CMOS) based image sensor.

The operation of the system 200 has been described later in conjunction with FIG. 3.

FIG. 3 is a flowchart 300 illustrating a method for detecting plagiarism in a conversation, in accordance with at least one embodiment. The flowchart 300 is described in conjunction with FIG. 1, and FIG. 2.

At step 302, a first input is received from the first user. In an embodiment, the microprocessor 202 may receive the first input that may correspond to a first audio signal from the first user. Prior to receiving the first input, the microprocessor 202 may establish a call with a second user associated with the interviewee-computing device 104. In an embodiment, the microprocessor 202 may initiate a VoIP session with the interviewee-computing device 104. In an embodiment, the scope of the disclosure is not limited to setting a VoIP session with the second user associated with the interviewee-computing device 104. In an embodiment, the microprocessor 202 may utilize any known protocol to initiate the call with the interviewee-computing device 104. In an embodiment, the microprocessor 202 may initiate a call with the second user through public switched telephone network (PSTN). In an embodiment, the first user may utilize an audio capturing device 216 attached or coupled to the interviewer-computing device 102 to communicate with the second user. The microprocessor 202 may utilize the audio capturing device 216 to sense the first audio signal associated with the first user. Thereafter, the microprocessor 202 receives the first audio signal from the audio capturing device 216. In an embodiment, the first audio signal may correspond to a query asked by the first user in the conversation. For instance, the first audio signal includes a voice reciting a query “what is data encapsulation”, asked by the first user to the second user.

At step 304, a second input is received from the second user. In an embodiment, the microprocessor 202 may receive the second input from the second user that may correspond to a second audio signal. As discussed above, similar to the interviewer-computing device 102, in an embodiment, the interviewee-computing device 104 may also have an audio capturing device attached to or coupled to the interviewee-computing device 104. In embodiment, the audio capturing device associated with the interviewee-computing device 104 may sense the second audio signed associated with the second user. Thereafter, the microprocessor 202 of the interviewer-computing device 102 may receive the second audio signal from the interviewee-computing device 104 through the transceiver 212. In an embodiment, the second audio signal may correspond to one or more responses received from the second user in response to the query asked by the first user. For instance, for the query “what is data encapsulation” asked by the first user, the second audio signal may include a voice reciting a response “The wrapping of data and operations into a single unit”.

At step 306, the one or more first words and the one or more second words are extracted. In an embodiment, the microprocessor 202 may extract the one or more first words and the one or more second words from the first audio signal and the second audio signal, respectively. In an embodiment, the microprocessor 202 may employ one or more known Automatic Speech Recognition (ASR) techniques to extract the one or more first words from the first audio signal and the one or more second words from the second audio signal. The automatic speech recognition techniques may include, but are not limited to HTK, Sphinx, and so on.

In an embodiment, the microprocessor 202 may further process the speech by utilizing an accent resilient speech technique. In the post processing of the ASR transcript, the microprocessor 202 may enable the accent resilient speech, in which the one or more first words from the first audio signal and the one or more second words from the second audio signal are expanded along with a semantic expansion and accent/acoustic similarities.

In an embodiment, the microprocessor 202 may store the extracted one or more first words, and the one or more second words along with their corresponding timestamps in an index file. In an embodiment, the index file may correspond to an xml file or a look up table that may be stored in the memory 206.

At step 308, the one or more first words and the one or more second words in the conversation are processed. In an embodiment, the microprocessor 202 processes the one or more first words and the one or more second words. In an embodiment, the microprocessor 202 may employ one or more text-processing techniques to process the one or more first words and the one or more second words. In an embodiment, the text processing may involve removing one or more stop words, converting digits to textual forms, identifying parts of speech, or stemming the one or more first words and the one or more second words.

Text processing by removing stop words

The stop words may consist of high-frequency function words such as, but not limited to, “is”, “an”, “the”, and “from”. Such high frequency words may not be relevant or of interest to the first user. Therefore, the high-frequency function words are removed. For example, if the conversation consists of a string such as “Receive an input from the user”, the microprocessor 202 may remove stop words such as ‘an’ and ‘the’ from the string associated with the conversation.

### Text Processing by Converting Digits to Textual Forms

In an embodiment, the microprocessor 202 may convert digits in the first audio signal and the second audio signal in the conversation to textual forms. For example, the first audio signal and the second audio signal include digits such as ‘2’ or ‘3’, etc. In such cases, the microprocessor 202 transforms each digit to its textual form, i.e., ‘two’, or ‘three’, while performing speech to text conversion.

### Text Processing by Identifying Parts of Speech

In an embodiment, the microprocessor 202 may identify parts of speech in the first audio signal and the second audio signal. The parts of speech may include, but are not limited to noun, pronoun, adjective, verb, or adverb and so on. For example, if the conversation consists of a string such as “In ancient times, life was hard”, the microprocessor 202 may extract the part of speech such as “ancient” from the string (i.e., an adjective). Similarly, if the conversation consists of a string such as “The Central Intelligence Agency is a government agency”, the microprocessor 202 may extract part of speech such as “ Central Intelligence Agency”, and “agency” (i.e., nouns), and so on.

Text Processing through Stemming

Stemming is a process of transforming a word to a root form. The stemming may transform each of the one or more first words and the one or more second words associated with the first audio signal and the second audio signal, respectively, to a stem form. For example, if the one or more first words and the one or more second words include words such as “finding”, “find”, “finds”. In such cases, the microprocessor 202 transforms each such word to a respective root form, i.e., “find”.

In another scenario, there may exist words that cannot be transformed to the root form. For example, the first audio signal and the second audio signal in the conversation consist of words such as “course”, “courses”, etc. The microprocessor 202 transforms each such word to “cours”. Therefore, stemming of such words may lead to nonsensical words that may reduce the readability of the words. Thus, to overcome such type of stemming, the microprocessor 202 may employ a reverse stemming technique. The reverse stemming technique may transform each such stem word (i.e., nonsensical words) to an original word form based on a frequency count of the nonsensical stem word. As discussed in the above example, the microprocessor 202 transforms each “course”, “courses” words to “cours” which is difficult to read or is not understandable. The microprocessor 202 may identify such non-understandable stem words. In an embodiment, the microprocessor 202 may utilize a dictionary to identify such words. In an embodiment, the dictionary may be stored in the memory 206. Post identifying such non-understandable stem words, the microprocessor 202 determines a count of occurrences of such non-understandable stem words (e.g., cours). For example, if “course” occurred 3 times and “courses” occurred “4 times”, the count for the stem word “cours” is 7 times. The microprocessor 202 may convert such non-understandable stem words to their original form based on the count of the original words. Hence, all the occurrences of the stem word “cours” will be converted to “courses”, as the occurrence of word “courses” is more than the word “course”.

A person having ordinary skill in the art would appreciate that the scope of the disclosure is not limited to the above disclosed text processing techniques. In an embodiment, the microprocessor 202 may employ other text processing techniques such as by expanding abbreviations, by removing special characters, and the like, without departing from the scope of the disclosure.

In an embodiment, the microprocessor 202 may analyze the second audio signal by using one or more speech recognition techniques to determine a delay in the one or more responses of the second user. In order to determine the delay, the microprocessor 202 may analyze a spectrum of the second audio signal. In an embodiment, the microprocessor 202 may determine one or more parameters, associated with the spectrum, such as, an amplitude of the second audio signal and a frequency of the second audio signal. The one or more parameters may be deterministic of at least one of a speech rate, a volume or a pitch of the speaker, pauses in the second audio signal, and so on, which in turn may be used by the microprocessor 202 to determine the delay.

At step 310, a query is created from the one or more first words. In an embodiment, the microprocessor 202 may create the query from the one or more first words. A person having ordinary skill in the art would appreciate that the one or more first words may correspond to the stemmed words (refer to the step 308). However, the scope of the disclosure is not limited to creating the query using the one or more stemmed words. In an embodiment, the one or more original extracted first words may be used for creating the query. For example, as discussed above, the microprocessor 202 extracts one or more first words (i.e., “data” and “encapsulation”) from the first audio signal. Further, the microprocessor 202 creates the query (i.e., “data encapsulation”) from the extracted one or more first words.

In an embodiment, the microprocessor 202 may create the query from the identified parts of speech. The parts of speech includes nouns, proper nouns, verbs, and the like, as discussed in the step 308. Further, the microprocessor 202 groups the noun/proper-nouns to create the query. For example, if the conversation includes a string such as “I can solve this mathematical equation”, the microprocessor 202 identifies the part of speech of the string. Thereafter, the microprocessor 202 creates the query based on the identified parts of speech (i.e., the pronoun “I” and the noun “mathematical equation”).

At step 312, the microprocessor 202 may query one or more websites. In an embodiment, the microprocessor 202 may query the one or more websites to obtain content. The content may include one or more phrases or one or more third words. For example, as discussed above, the query is “data encapsulation”. Further, the microprocessor 202 may query the one or more websites. Examples of the one or more websites may include, but are not limited to, Yahoo, Google, ask.com, or Wikipedia. Following Table 1 illustrates the content obtained from the one or more websites for the query “data encapsulation”:

TABLE 1
Illustration of the content obtained from one or more websites

| Yahoo | Google | Wikipedia |
|---|---|---|
| Encapsulation is the | Data encapsulation is a | Data encapsulation, also |
| process of combining data | concept of combining data | known as data hiding, is |
| and functions into a single | with the methods to be | the mechanism whereby |
| unit called class. Using | performed on that data. | the implementation details |
| the method of | Abstract data types are an | of a class are kept hidden |
| encapsulation, the | implementation of the | from the user. The user |
| programmer cannot | concept of data | can only perform a |
| directly access the data. | encapsulation. | restricted set of |
| Data is only accessible | | operations on the hidden |
| through the functions | | members of the class by |
| present inside the class. | | executing special |
| Data encapsulation led to | | functions commonly |
| the important concept of | | called methods. |
| data hiding. Data hiding is | | |
| the implementation details | | |
| of a class that are hidden | | |
| from the user. The | | |
| concept of restricted | | |
| access led programmers | | |
| to write specialized | | |
| functions or methods for | | |
| performing the operations | | |
| on hidden members of the | | |
| class. Attention must be | | |
| paid to ensure that the | | |
| class is designed | | |
| properly. | | |

Referring to the Table 1, the microprocessor 202 may transmit the query to the websites such as Yahoo, Google, or Wikipedia to obtain the content. The content may include different definitions of the query “data encapsulation”. In an embodiment, the content may be stored in the memory 206 in different file formats as per the known source file formats. For instance, the content from yahoo website may be in “XML” or “JSON” format. Similarly, the content from Wikipedia may be in “text data” format. In an embodiment, the first user associated with the interviewer-computing device 102 may manually enter the query to obtain the content from the one or more websites.

A person skilled in the art would understand that the above-mentioned Table 1 has been provided only for illustration purposes, and should not limit the scope of the disclosure to these websites only. In an embodiment, the microprocessor 202 may query to different websites as per the query, without departing from the scope of the disclosure.

Post receiving the content, the microprocessor 202 may further perform the text processing of the content received from the one or more websites. The text processing techniques may include, but are not limited to, removing one or more stop words, converting digits to textual forms, identifying parts of speech, or stemming the one or more third words, as discussed in the step 308.

At step 314, the one or more second words and the one or more third words are parameterized. In an embodiment, the microprocessor 202 may parameterize the one or more second words obtained from the one or more responses of the second user and the one or more third words of the content obtained from the one or more websites respectively, (as discussed above) to form a lingual representation of the one or more second words and the one or more third words. Examples of parameterization may include, but are not limited to, a frequency vector, an n-gram frequency representation, or a frequent near-similar phrase detection. For example, in an embodiment, the microprocessor 202 may utilize the frequency vector to determine the frequency of each stemmed one or more second words and the one or more third words in the dictionary. In an embodiment, the microprocessor 202 may further provide a default frequency of zero to the terms that are not present in the one or more second words and the one or more third words.

In an embodiment, the microprocessor 202 may determine a count of each of the one or more second words and the one or more third words in the one or more responses and the content received from the one or more websites, respectively. Further, the microprocessor 202 may identify the parts of speech tags in the one or more second words and the one or more third words, as discussed above. Thereafter, the microprocessor 202 may create a vector of each of the identified parts of speech tags. In an embodiment, the part of speech tags of ‘noun’ may include (NN, NNP, NNS: i.e., common noun, proper noun, singular or plural nouns, and so on), ‘adjective’ may include (JJ, JJR, JJS, i.e., simple comparative or superlative adjectives), and ‘adverb’ may include (RB, RBR, RBS, i.e., simple, comparative or superlative adverbs) along with the stemmed one or more second words and the one or more third words. Based on the vector with the count of each of the one or more second words and the one or more third words in the one or more responses and the content, respectively, the microprocessor 202 creates the lingual representation of the one or more second words and the one or more third words.

At step 316, a first score for the one or more websites is determined. In an embodiment, the microprocessor 202 may determine the first score for the one or more websites based on a comparison between the one or more responses of the second user and the content obtained from the one or more websites. A person having ordinary skill in the art would appreciate that the one or more responses may correspond to the processed second words (refer to the step 308) and the content may correspond to processed third words (refer to the step 312). However, the scope of the disclosure is not limited to determining the first score for the one or more websites using the one or more processed second words and the processed third words. In an embodiment, the one or more original extracted second words and the one or more third words may be used for determining the first score for the one or more websites. In an embodiment, the microprocessor 202 may determine the first score by utilizing the parameterized one or more second words and parameterized one or more third words, as discussed above. The first score may correspond to a measure of similarity between the one or more second words and the one or more third words. In an embodiment, the first score may correspond to a first overlap quotient score. In an embodiment, the microprocessor may determine the measure of similarity between the one or more second words and the one or more third words by computing a cosine similarity. For example, in an embodiment, the microprocessor 202 may determine the cosine similarity between two vectors such as A=[a1,a2, . . . , an] and B=[b1,b2, . . . , bn] using the following equation:

$$Cossim ( A , B ) = \frac{{Σ}_{i = 1}^{n} {a}_{i} * {b}_{i}}{\sqrt{{Σ}_{i = 1}^{n} {a}_{i}^{2} * \sqrt{{Σ}_{i = 1}^{n} {b}_{i}^{2}}}} \qquad ( 1 )$$

where,

a=One or more responses of the second user,

b=Content obtained from one or more websites.

For example, as shown in the table 1, the microprocessor 202 may obtain the content from the one or more websites like Yahoo, Google, and Wikipedia for the query “data encapsulation”. The microprocessor 202 may utilize the equation 1 to determine the first score based on a comparison between the content and the one or more responses of the second user. Based on the measure of the similarity between the one or more responses of the second user and the content obtained from the one or more websites, the microprocessor 202 may determine the first score as 0.50, 0.44, and 0.35 for the one or more websites Yahoo, Google, and Wikipedia, respectively. In an embodiment, the microprocessor 202 may omit obvious terms in the query asked by the first user from the parametric representation to avoid an obvious bias while determining the cosine similarity. For example, if the query is “what is data encapsulation”, then the microprocessor 202 may omit obvious terms such as “is” and “what” while determining the cosine similarity.

In an embodiment, the microprocessor 202 may determine a second score based on the comparison. The comparison is performed between the one or more responses and the content, in response to the query. In an embodiment, the second score may correspond to a measure of dissimilarity between the one or more responses and the content. For example, the query is “What is logistic regression”. The microprocessor 202 obtains the content from the one or more websites for the query and the one or more responses from the second user in response to the query. Further, the microprocessor 202 determines the measure of dissimilarity between the content and the one or more responses by utilizing the cosine similarity as discussed above.

A person skilled in the art would understand that the above-mentioned method (i.e., cosine similarity) has been provided only for illustration purposes, and should not limit the scope of the disclosure. In an embodiment, the microprocessor 202 may employ other methods such as, but not limited to, one or more probabilistic or deterministic methods without departing from the scope of the disclosure.

In an embodiment, the microprocessor 202 may determine a longest common subsequence (LCS) between the content and the one or more responses of the second user, i.e., let say question is “data encapsulation” and response which we recorded as “Encapsulation is the packing of data into single component” and we got web answer as “Encapsulation is the packing of functions and data into a single component” then LCS is “Encapsulation is the packing of data into a single component” and LCS length is 9. Further, the microprocessor 202 may determine a length of the LCS. Based on the length of the LCS, the microprocessor 202 determines the plagiarism in the conversation. For instance, if the length of the LCS is greater than a predetermined threshold, then the microprocessor 202 may determine that there may be chances of the plagiarism in the conversation. In an embodiment, the LCS may be determined without any text processing of the content and the one or more responses of the second user.

At step 318, the one or more websites are ranked. In an embodiment, the microprocessor 202 may rank the one or more websites based on the first score for the one or more websites. The microprocessor 202 may determine the first score for the one or more websites between the one or more responses of the second user and the content obtained from the one or more websites, as discussed above. For example, as discussed above, the first score for yahoo, Google, and Wikipedia are 0.5, 0.44, and 0.35, respectively. Based on the first score, the microprocessor 202 ranks the one or more websites (i.e., yahoo, Google, and Wikipedia).

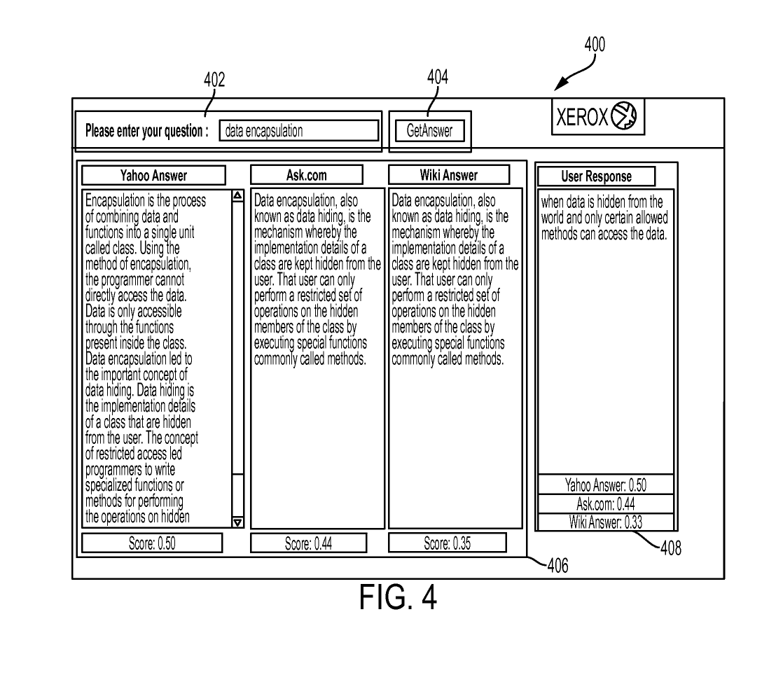

At step 320, a graphical user interface is presented to the first user. In an embodiment, the microprocessor 202 may present the graphical user interface to the first user. The graphical user interface may facilitate the display of the ranked one or more websites. In an embodiment, the graphical user interface may include an input box and a region. The input box may facilitate the first user to enter the query. On the other hand, the region may be configured to display the content obtained from the one or more websites and the respective first score. Based on the display of the ranked one or more websites and the first score, the microprocessor 202 may allow the first user to detect the plagiarism in the conversation. The graphical user interface has been described later in conjunction with the FIG. 4.

FIG. 4 is a block diagram illustrating a graphical user interface 400 presented to a first user, in accordance with at least one embodiment. The graphical user interface 400 has been described in conjunction with FIG. 1, FIG. 2, and FIG. 3.

A graphical user interface, GUI, (depicted by 400) is presented to the first user. The GUI 400 includes an input box 402 that enables the first user to enter the query. In an embodiment, the input box 402 may be a text box in which the first user may input the query. The GUI 400 further includes a button 404 that enables the first user to obtain the content from the one or more websites.

The GUI 400 further includes a first region 406 that is configured to display the content obtained from the one or more websites, and the respective first score. The GUI 400 further includes a second region 408 that is configured to display the response of the second user and the ranked one or more websites based on the first score.

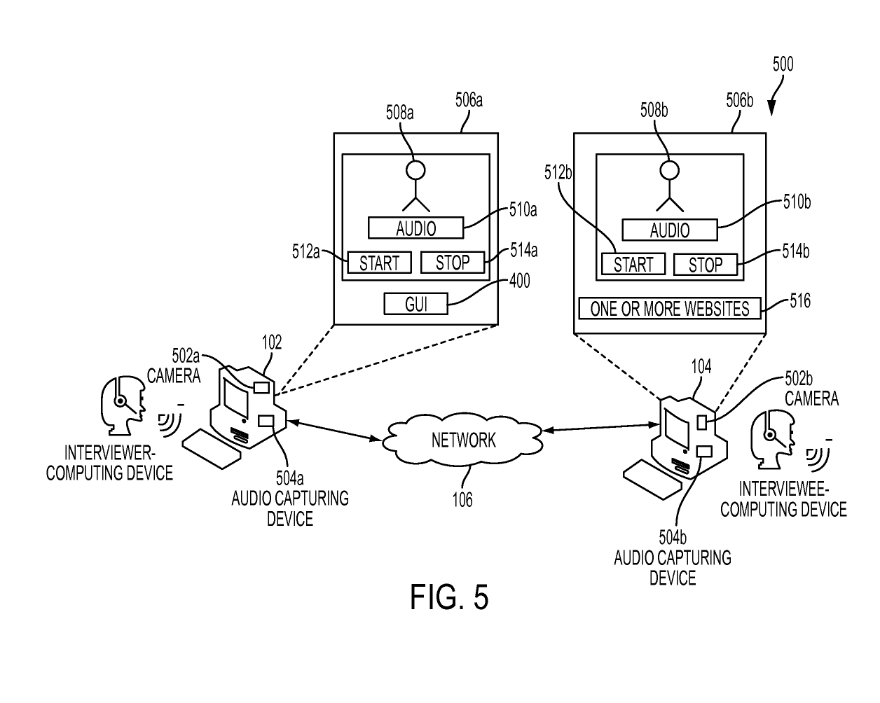

FIG. 5 is another block diagram illustrating a system environment 500 in which various embodiments may be implemented. The system environment 500 includes the interviewer-computing device 102, the interviewee-computing device 104, and the network 106. Various devices in the system environment 500 (e.g., the interviewer-computing device 102, and the interviewee-computing device 104) may be interconnected over the network 106.

The interviewer-computing device 102 may be utilized by the first user to initiate the call with the interviewee-computing device 104 through a video conference session. In an embodiment, the microprocessor 202 may initiate the video conference session between the first user associated with the interviewer-computing device 102 and the second user associated with the interviewee-computing device 104. In an embodiment, the interviewer-computing device 102 may include a camera (depicted by 502a). The camera 502a captures a video footage of the first user while the first user is asking the query from the second user. Further, the interviewer-computing device 102 may include an audio capturing device 504a to sense the first audio signal of the first user. The interviewer-computing device 102 may include a screen (depicted by 506a). The screen 506a displays an image (depicted by 508a) of the second user associated with the interviewee-computing device 104, who is responding to the query asked by the first user. In an embodiment, the image 508a may be utilized by the first user to determine the facial expressions of the second user. In an alternate embodiment, the microprocessor 202, may utilize one or more image processing techniques to determine the facial expressions. The screen 506a further includes an audio button (depicted by 510a), a start button (depicted by 512a), a stop button (depicted by 514a), and the GUI (depicted by 400). The audio button 510a may be utilized to start a capturing of the second audio signal received from the second user through an audio capturing device (depicted by 514a) associated with the interviewee-computing device 104. The second audio signal may be utilized to determine the one or more parameters of speech of the second user such as, but not limited to, a speech rate, a volume or pitch of the second user, hesitation in the voice of the second user, etc. Further, the start button 512a may be utilized by the first user to initiate the session. On the other hand, the stop button 514a may be utilized by the first user to end the session. Further, the GUI 400 has already been described in conjunction with the FIG. 4. Further, the GUI 400 may be utilized to determine the plagiarism in the conversation.

On the other hand, the interviewee-computing device 104 may include a camera (depicted by 502b). The camera 502b captures a video footage of the second user while the second user is responding to the query asked by the first user. Further, the interviewer-computing device 102 may include an audio capturing device 504b to sense the second audio signal of the second user. Further, the interviewee-computing device 104 may include a screen (depicted by 506b). The screen 506b displays an image (depicted by 508b) of the first user associated with the interviewer-computing device 102, who is asking the query from the second user. The screen 506b further includes an audio button (depicted by 510b), a start button (depicted by 512b), a stop button (depicted by 514b), and one or more websites (depicted by 516). The audio button 510b may be utilized to start a capturing of the first audio signal received from the first user through the audio capturing device (depicted by 504b) associated with the interviewer-computing device 102. Further, the start button 512b may be utilized by the second user to initiate the session. On the other hand, the stop button 514b may be utilized by the second user to end the session. Further, the one or more websites 516 may be utilized by the second user to obtain the content for the query asked by the first user.

The disclosed embodiments encompass numerous advantages. Various embodiments of methods and systems for detecting plagiarism in conversations have been disclosed. The disclosure provides for an establishment of a communication medium between an interviewer and an interviewee. Examples of such communication mediums include, but are not limited to, a VoIP session, a video conferencing session, and a PSTN call. While the interviewer asks a query from the interviewee, a first audio signal received from the interviewer is captured. Further, while the interviewee responds to the query by providing a response, a second audio signal received from the interviewee is also captured. Based on an analysis of the first audio signal, one or more first words are extracted from the query. Further, based on an analysis of the second audio signal, one or more second words are extracted from the response. The interviewer is presented with a user interface, in which the interview may enter the query asked to the interviewee (i.e., the one or more first words). Thereafter, the user interface may display a ranked list of one or more websites to the interviewer. The ranking of the one or more websites may be based on a similarity of content obtained from the one or more websites (i.e., one or more third words) to the one or more second words present in the response. Thus, the interviewer may be able determine the plagiarism in the response of the interviewee. Further, the interviewer may be able to determine whether the interviewee is suitable for a job or not.

The disclosed methods and systems, as illustrated in the ongoing description or any of its components, may be embodied in the form of a computer system. Typical examples of a computer system include a general purpose computer, a programmed microprocessor, a micro-controller, a peripheral integrated circuit element, and other devices, or arrangements of devices that are capable of implementing the steps that constitute the method of the disclosure.

The computer system comprises a computer, an input device, a display unit, and the internet. The computer further comprises a microprocessor. The microprocessor is connected to a communication bus. The computer also includes a memory. The memory may be RAM or ROM. The computer system further comprises a storage device, which may be a HDD or a removable storage drive such as a floppy-disk drive, an optical-disk drive, and the like. The storage device may also be a means for loading computer programs or other instructions onto the computer system. The computer system also includes a communication unit. The communication unit allows the computer to connect to other databases and the internet through an input/output (I/O) interface, allowing the transfer as well as reception of data from other sources. The communication unit may include a modem, an Ethernet card, or similar devices that enable the computer system to connect to databases and networks such as LAN, MAN, WAN, and the internet. The computer system facilitates input from a user through input devices accessible to the system through the I/O interface.

To process input data, the computer system executes a set of instructions stored in one or more storage elements. The storage elements may also hold data or other information, as desired. The storage element may be in the form of an information source or a physical memory element present in the processing machine.

The programmable or computer-readable instructions may include various commands that instruct the processing machine to perform specific tasks such as steps that constitute the method of the disclosure. The systems and methods described can also be implemented using only software programming, only hardware, or a varying combination of the two techniques. The disclosure is independent of the programming language and the operating system used in the computers. The instructions for the disclosure can be written in all programming languages including, but not limited to, “C,” “C++,” “Visual C++,” and “Visual Basic”. Further, software may be in the form of a collection of separate programs, a program module containing a larger program, or a portion of a program module, as discussed in the ongoing description. The software may also include modular programming in the form of object-oriented programming. The processing of input data by the processing machine may be in response to user commands, the results of previous processing, or from a request made by another processing machine. The disclosure can also be implemented in various operating systems and platforms, including, but not limited to, “Unix,” “DOS,” “Android,” “Symbian,” and “Linux.”

The programmable instructions can be stored and transmitted on a computer-readable medium. The disclosure can also be embodied in a computer program product comprising a computer-readable medium, with any product capable of implementing the above methods and systems, or the numerous possible variations thereof.

Various embodiments of the methods and systems for detecting plagiarism in the conversation have been disclosed. However, it should be apparent to those skilled in the art that modifications, in addition to those described, are possible without departing from the inventive concepts herein. The embodiments, therefore, are not restrictive, except in the spirit of the disclosure. Moreover, in interpreting the disclosure, all terms should be understood in the broadest possible manner consistent with the context. In particular, the terms “comprises” and “comprising” should be interpreted as referring to elements, components, or steps, in a non-exclusive manner, indicating that the referenced elements, components, or steps may be present, used, or combined with other elements, components, or steps that are not expressly referenced.

A person with ordinary skills in the art will appreciate that the systems, modules, and sub-modules have been illustrated and explained to serve as examples and should not be considered limiting in any manner. It will be further appreciated that the variants of the above disclosed system elements, modules, and other features and functions, or alternatives thereof, may be combined to create other different systems or applications.

Those skilled in the art will appreciate that any of the aforementioned steps and/or system modules may be suitably replaced, reordered, or removed, and additional steps and/or system modules may be inserted, depending on the needs of a particular application. In addition, the systems of the aforementioned embodiments may be implemented using a wide variety of suitable processes and system modules, and are not limited to any particular computer hardware, software, middleware, firmware, microcode, and the like.

The claims can encompass embodiments for hardware and software, or a combination thereof.

It will be appreciated that variants of the above disclosed, and other features and functions or alternatives thereof, may be combined into many other different systems or applications. Presently unforeseen or unanticipated alternatives, modifications, variations, or improvements therein may be subsequently made by those skilled in the art that are also intended to be encompassed by the following claims.

What is claimed is:

1. A method for detecting plagiarism in a conversation, said method comprising:
receiving, by one or more microprocessors, a first input corresponding to a query from a first user in said conversation, wherein said first input corresponds to at least a first audio signal received from said first user;
receiving, by said one or more microprocessors, a second input corresponding to one or more responses received from a second user in response to said query, wherein said second input corresponds to at least a second audio signal received from said second user; and
determining, by said one or more microprocessors, a first score for one or more websites, based on a comparison between said one or more responses and content obtained from said one or more websites in response to said query, wherein said first score is a measure of a similarity between said one or more responses and said content.

2. The method of claim 1 further comprising analyzing, by said one or more microprocessors, said second audio signal to determine a delay in said one or more responses of said second user.

3. The method of claim 1 further comprising extracting, by said one or more microprocessors, one or more first words from said first audio signal and one or more second words from said second audio signal, by utilizing one or more speech recognition techniques.

4. The method of claim 3 further comprising processing, by said one or more microprocessors, said one or more first words and said one or more second words to remove one or more stop words, convert digits to textual forms, identify part of speech, or stem said one or more first words, said one or more second words.

5. The method of claim 3 further comprising creating, by said one or more microprocessors, said query from said one or more first words.

6. The method of claim 5 further comprising querying, by said one or more microprocessors, said one or more websites to obtain said content, wherein each of said content includes one or more phrases or one or more third words.

7. The method of claim 6 further comprising determining, by said one or more microprocessors, a count of each of said one or more second words, and said one or more third words, in said one or more responses and said content, respectively.

8. The method of claim 7 further comprising determining, by said one or more microprocessors, a cosine similarity between said one or more third words, and said one or more second words to determine said first score.

9. The method of claim 1 further comprising ranking, by said one or more microprocessors, of said one or more websites based on said determined first score.

10. The method of claim 9 further comprising presenting, by said one or more microprocessors, a graphical user interface to said first user, wherein said graphical user interface facilitates display of said ranked one or more websites.

11. The method of claim 10, wherein said graphical user interface further comprises at least an input box and a region.

12. The method of claim 11, wherein said region is configured to display said content obtained from said one or more websites, and respective said first score.

13. The method of claim 11, wherein said input box facilitates said first user to enter said query.

14. The method of claim 1 further comprising determining, by said one or more microprocessors, a second score based on said comparison between said one or more responses of said second user, in said conversation with at least said first user, for said query, and said content obtained from said one or more websites in response to said query, wherein said second score is a measure of a dissimilarity between said one or more responses and said content.

15. A method for detecting plagiarism in an interview, said method comprising:
extracting, by one or more microprocessors, one or more first words from a first audio signal received from an interviewer, and one or more second words from a second audio signal received from an interviewee in said interview, wherein said first audio signal corresponds to a query asked by said interviewer to said interviewee, and wherein said second audio signal corresponds to at least a response of said interviewee;
processing, by said one or more microprocessors, said one or more first words, and said one or more second words to remove one or more stop words, convert digits to textual forms, identify part of speech, or stem said one or more first words, said one or more second words;
creating, by said one or more microprocessors, said query from said one or more first words;
transmitting, by said one or more microprocessors, said query to one or more websites to obtain content, wherein each of said content includes one or more phrases or one or more third words; and
determining, by said one or more microprocessors, a first score based on a comparison between said one or more second words and said content obtained from said one or more websites in response to said query, wherein said first score is a measure of a similarity between said one or more second words and said content.

16. A system for detecting plagiarism in a conversation, said system comprising:
one or more microprocessors configured to:
receive a first input corresponding to a query from a first user in said conversation, wherein said first input corresponds to at least a first audio signal received from said first user;
receive a second input corresponding to one or more responses received from a second user in response to said query, wherein said second input corresponds to at least a second audio signal received from said second user; and
determine a first score for one or more websites, based on a comparison between said one or more responses and content obtained from said one or more websites in response to said query, wherein said first score is a measure of a similarity between said one or more responses and said content.

17. The system of claim 16, wherein said one or more microprocessors are configured to extract one or more first words from said first audio signal and one or more second words from said second audio signal, by utilizing one or more speech recognition techniques.

18. The system of claim 17, wherein said one or more microprocessors are further configured to process said one or more first words and said one or more second words to remove one or more stop words, convert digits to textual forms, identify part of speech, or stem said one or more first words, said one or more second words.

19. The system of claim 17, wherein said one or more microprocessors are further configured to create said query from said one or more first words.

20. The system of claim 19, wherein said one or more microprocessors are further configured to query said one or more websites to obtain said content, wherein each of said content includes one or more phrases or one or more third words.

21. The system of claim 20, wherein said one or more microprocessors are further configured to determine a count of each of said one or more second words, and said one or more third words, in said one or more responses and said content, respectively.

22. The system of claim 16, wherein said one or more microprocessors are further configured to rank said one or more websites based on said determined first score.

23. The system of claim 22, wherein said one or more microprocessors are further configured to present a graphical user interface to said first user, wherein said graphical user interface facilitates display of said ranked one or more websites.

24. A computer program product for use with a computer, the computer program product comprising a non-transitory computer readable medium, wherein the non-transitory computer readable medium stores a computer program code for detecting plagiarism in a conversation, wherein said computer program code is executable by one or more processors to:
receive, by one or more microprocessors, a first input corresponding to a query from a first user in said conversation, wherein said first input corresponds to at least a first audio signal received from said first user;
receive, by said one or more microprocessors, a second input corresponding to one or more responses received from a second user in response to said query, wherein said second input corresponds to at least a second audio signal received from said second user; and
determine, by said one or more microprocessors, a first score for one or more websites, based on a comparison between said one or more responses and content obtained from said one or more websites in response to said query, wherein said first score is a measure of a similarity between said one or more responses and said content.
